(19) United States
(12) Patent Application Publication
(10) Pub. No.: US 2010/0245097 A1
(43) Pub. Date: Sep. 30, 2010

(54) GAS SUPPLY APPARATUS

(75) Inventor: Ching-Lung Sung, Taichung City (TW)

Correspondence Address: SNYDER, CLARK, LESCH & CHUNG, LLP, 950 Herndon Parkway, Suite 365, HERNDON, VA, 20170, US

(73) Assignee: TOP VISION MEDICAL EQUIPMENT CONSULTANT CO., LTD., The Valley (AI)

(21) Appl. No.: 12/748,603

(22) Filed: Mar. 29, 2010

(30) Foreign Application Priority Data
Mar. 31, 2009 (TW) 098110624

(51) Int. Cl. G08B 21/00

(52) U.S. Cl. 340/627

(57) ABSTRACT

A gas supply apparatus is adapted for supplying gas to a respiratory mask or patient interface, and includes: a housing including a gas inlet, a gas outlet, and a gas flow path; a blower disposed within the gas flow path; a gas filter disposed within the gas flow path; a breath tubing for connecting to the respiratory mask or patient interface; a particle sensor operable to sense a particle concentration and to generate a concentration signal representative of the particle concentration; a signal processor operable to evaluate when the gas filter should be replaced or cleaned according to the concentration signal and to generate an output signal; and an indicator device generating an alarm signal in response to the output signal.

### CROSS-REFERENCE TO RELATED APPLICATION

This application claims priority of Taiwanese application No. 098110624, filed on Mar. 31, 2009.

### BACKGROUND OF THE INVENTION

1. Field of the Invention

This invention relates to a gas supply apparatus, more particularly to a gas supply apparatus including a particle sensor for sensing a particle concentration in gas and an indicator device for indicating whether a gas filter in the gas supply apparatus should be replaced or cleaned.

2. Description of the Related Art

A conventional gas supply apparatus is provided to introduce a gas flow into a respiratory mask or patient interface (medical ventilator such as CPAP or BiPAP for obstructive sleep apnea (OSA), (chronic obstructive pulmonary disease (COPD) patient) by using a blower or turbine for a patient to smoothly breathe. The conventional gas supply apparatus usually includes a filter, such as foam, pollen or ultrafine type, for removing suspended particles from the gas. However, the inlet gas flow after passing through the filter is not analyzed and the analyzed result is not indicated to the patient. Therefore, a patient with respiratory disorders, such as chronic obstructive pulmonary disease (COPD), or obstructive sleep apnea (OSA), may not breathe clean gas when the filter is dusty or fails to function properly.

In addition, internal components of the gas supply apparatus may be polluted or damaged by dusty gas which flows into the gas supply apparatus.

### SUMMARY OF THE INVENTION

Therefore, an object of the present invention is to provide a gas supply apparatus that can overcome the aforesaid drawbacks associated with the prior art.

According to the present invention, a gas supply apparatus is adapted for supplying gas to a respiratory mask or patient interface, and comprises: a housing including a gas inlet, a gas outlet, and a gas flow path extending between and in fluid connection with the gas inlet and the gas outlet; a blower disposed within the gas flow path for drawing gas into the gas flow path; a gas filter disposed within the gas flow path for filtering the gas; a breath tubing in fluid connection with the gas outlet of the housing for connecting to the respiratory mask or patient interface; a particle sensor disposed within the housing, and operable to sense a particle concentration in gas and to generate a concentration signal representative of the particle concentration; a signal processor electrically coupled to the particle sensor, and operable to evaluate when the gas filter should be replaced or cleaned according to the concentration signal and to generate an output signal; and an indicator device electrically connecting to the signal processor and generating an alarm signal in response to the output signal.

### BRIEF DESCRIPTION OF THE DRAWINGS

Other features and advantages of the present invention will become apparent in the following detailed description of the preferred embodiments of this invention, with reference to the accompanying drawings, in which:

FIG. 1 is a schematic diagram of the first preferred embodiment of a gas supply apparatus according to this invention;

FIG. 2 is a simplified schematic circuit block diagram of the first preferred embodiment;

FIG. 3 is a diagram showing a relation between voltage and time;

FIG. 4 is a plot showing a relation between time ratio and particle concentration;

FIG. 5 is a schematic diagram of the first preferred embodiment illustrating an indicator device;

FIG. 6 is a schematic diagram of the second preferred embodiment of the gas supply apparatus according to this invention; and

FIG. 7 is a simplified schematic circuit block diagram of the second preferred embodiment.

### DETAILED DESCRIPTION OF THE PREFERRED EMBODIMENTS

Before the present invention is described in greater detail with reference to the accompanying preferred embodiments, it should be noted herein that like elements are denoted by the same reference numerals throughout the disclosure.

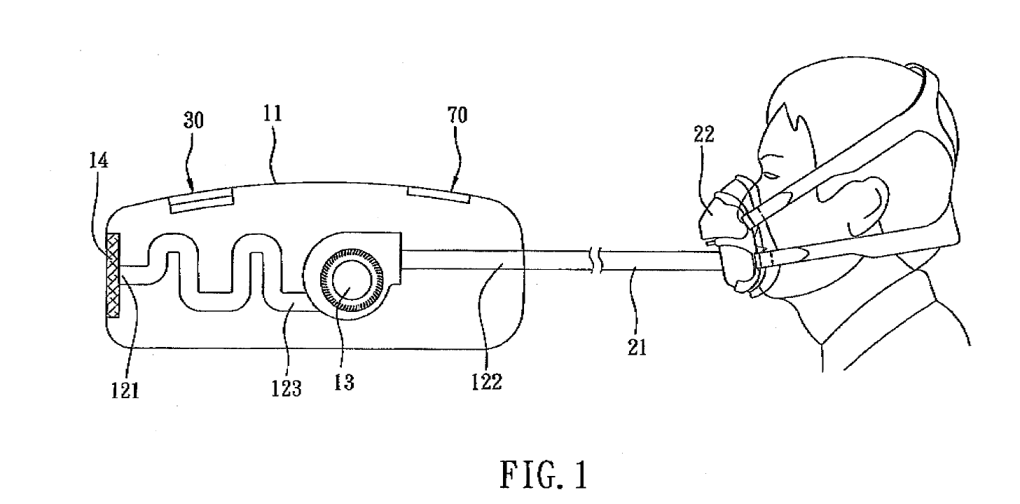

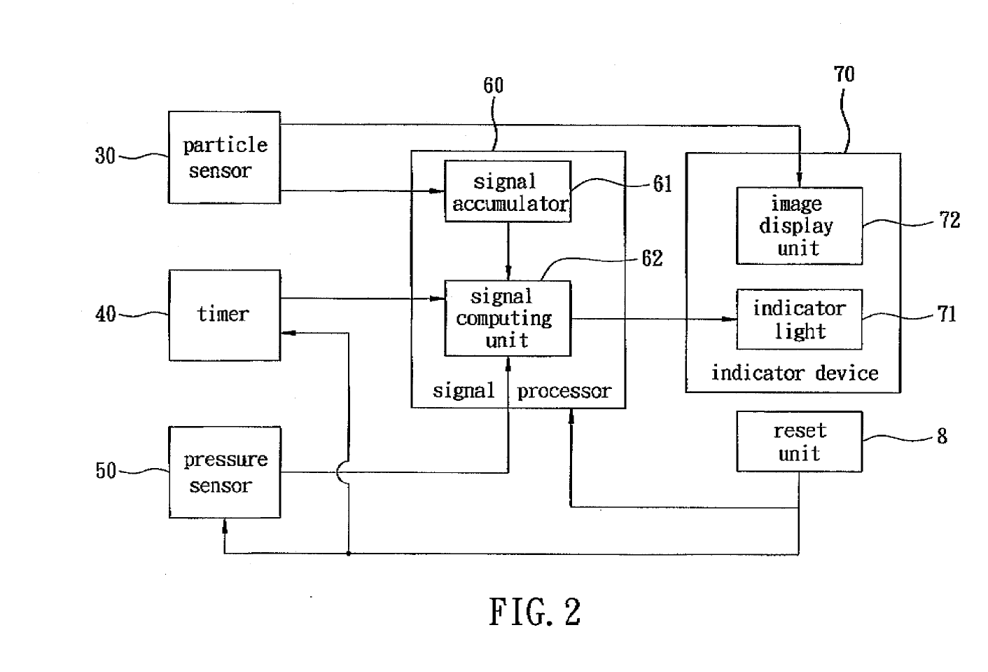

FIGS. 1 and 2 illustrate a gas supply apparatus of the first preferred embodiment according to this invention. The gas supply apparatus is adapted for supplying gas to a respiratory mask 22 or patient interface and includes a housing 11, a blower 13, a gas filter 14, a breath tubing 21, a particle sensor 30, a timer 40, a pressure sensor 50, a signal processor 60, an indicator device 70, and a reset unit 8.

The housing 11 includes a gas inlet 121, a gas outlet 122, and a gas flow path 123 extending between and in fluid connection with the gas inlet 121 and the gas outlet 122.

The blower 13 is disposed within the gas flow path 123 for drawing gas thereinto.

The gas filter 14 is disposed within the gas flow path 123 proximate to the gas inlet 121 for filtering the gas therethrough.

The breath tubing 21 is in fluid connection with the as outlet 122 of the housing 11 for connecting to the respiratory mask or patient interface involving nasal or full face mask, which is adapted to be tired or fixed to a patient's nose and/or mouth.

In this embodiment, the particle sensor 30 is a particle counter or weight. The particle sensor 30 is secured to the housing 11, and is operable to sense a particle concentration of suspension particles in the gas and to generate a concentration signal representative of the particle concentration in the gas.

An example of the particle counter or weight is a Particulate Matter Sensor, Model NO. PPD4NS, or a DUST sensor, Model NO. GP2Y1010AU0F (manufactured by SHAPR Corporation), which is used to detect the concentration of particles with a size greater than 1 μm.

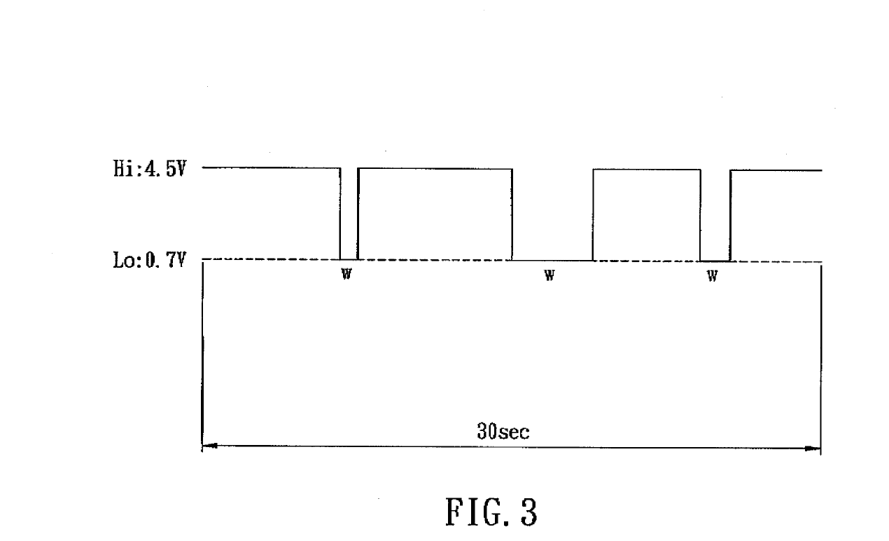

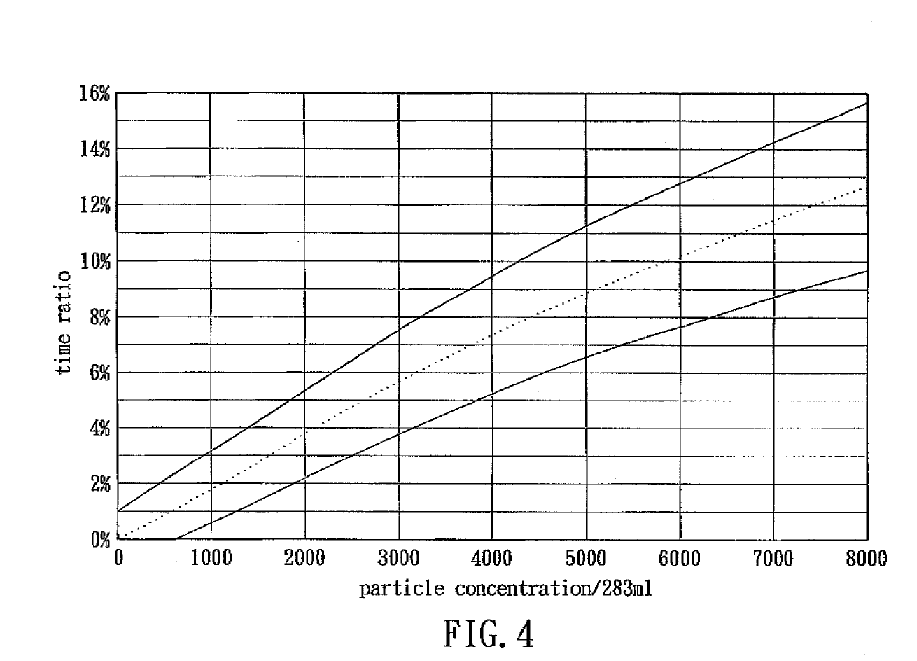

Referring to FIGS. 3 and 4, an operating principle of the Particulate Matter Sensor is based on light scattering technology. Generally, when a particle passes through a sensing zone and scatters light, a receptor receives the scattered light so as to generate a pulse signal, such as that shown in FIG. 3. When no particle passes through the sensing zone, the pulse signal rises to a high level of 4.5 Vdc. When particles pass through the sensing zone, the pulse signal falls to a low level of 0.7 Vdc. A unit time period used to detect the particles is 30 sec. Pulse durations (W) represent the durations in which the particles pass through the sensing zone. A plot of time ratio versus particle concentration is shown in FIG. 4. The time ratio may be obtained by calculating a ratio of a total of the pulse durations (W) to the unit time period (30 sec). The particle concentration related to the calculated time ratio may be evaluated from the plot.

The timer 40 is electrically coupled to the blower 13, and is operable to detect a working time of the blower 13, and to generate a time signal representative of the working time. The pressure sensor 50 is operable to sense a patient respiratory pressure in the gas flow path 123 and to generate a pressure signal representative of the pressure.

The signal processor 60 includes a signal accumulator 61 electrically coupled to the particle sensor 30, and is operable to sum up a total particle concentration based on the concentration signal so as to generate a total particle concentration signal. In addition, the signal processor 60 further includes a signal computing unit 62 electrically coupled to the signal accumulator 61, the tinker 40 and the pressure sensor 50, and operable to evaluate when the gas filter 14 should be replaced or cleaned according to the total particle concentration signal, the time signal and the pressure signal, and to generate an output signal.

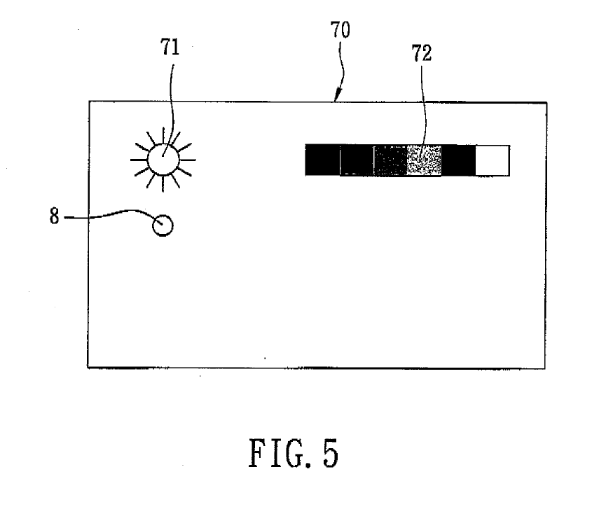

Referring to FIGS. 2 and 5, the indicator device 70 includes an indicator light 71 electrically connected to the signal processor 60 and providing a visual indication according to the output signal to indicate whether the gas filter 14 should be replaced or cleaned. The indicator device 70 further includes an image display unit 72 electrically connected to the particle sensor 30 for producing an image signal representative of the particle concentration according to the concentration signal. In addition, the reset unit B is provided to reset the signal processor 60, and the timer 40.

By virtue of the particle sensor 30 sensing the particle concentration, the pressure sensor 50 detecting the patient respiratory pressure in the gas flow path 123, and the timer 40 detecting the working time of the blower 13, the indicator device 70 is able to generate an alarm signal according to the signal processor 60 to notify when the gas filter 14 should be replaced or cleaned. Therefore, dusty gas can be prevented from entering into the gas flow path 123, thereby prolonging lifetime of internal mechanical components and protecting a user from breathing the dusty gas.

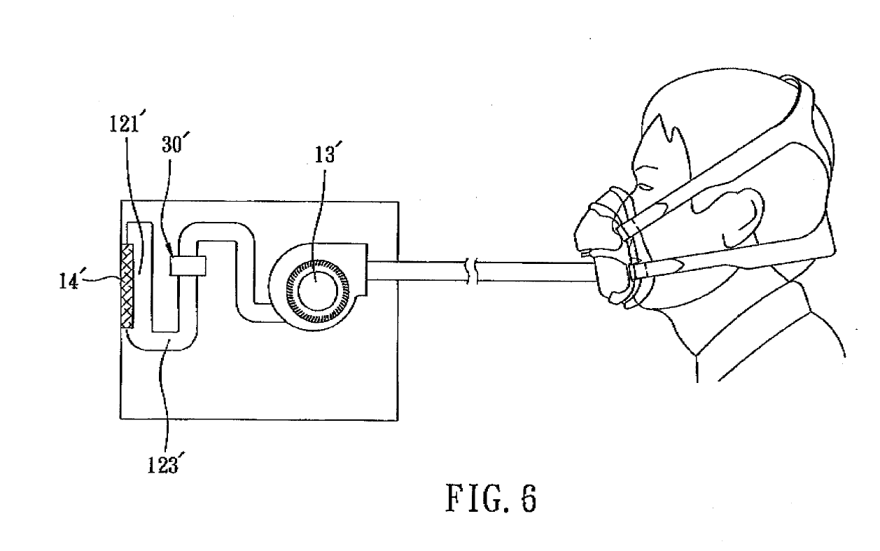

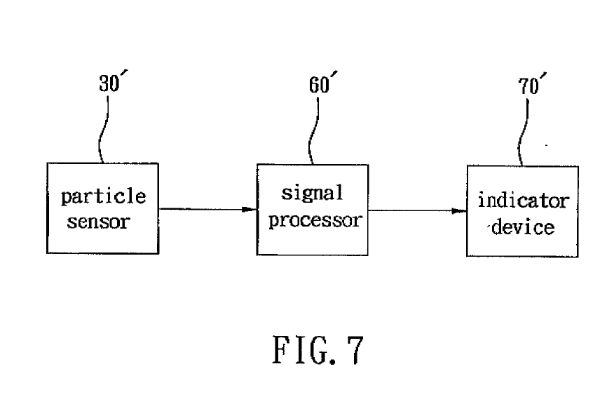

Referring to FIGS. 6 and 7, the second preferred embodiment of the present invention differs from the first preferred embodiment in that the particle sensor 30′ is disposed within the gas flow path 123′ between the gas inlet 121′ and the blower 13′ for sensing the particle concentration in the gas within the gas flow path 123′.

An operation of the second preferred embodiment is described hereinafter by way of example. The gas filter 14′ is one that can trap particles having a size greater than 1 μm. When the gas filter 14′ is used for a period of time, since the blower 13′ is continuously operated, the particles trapped in the gas filter 14′ will abrade and damage the gas filter 14′, thereby allowing the particles having a size greater than 1 μm to pass therethrough. When the particles having a size greater than 1 μm enter the gas flow path 123′, the particle sensor 30′ will sense and generates the concentration signal, and the signal processor 60′ receives the concentration signal and generate an output signal. The indicator device 70′ provides a visual indication based on the output signal to notify that the gas filter 14′ requires replacement or cleaning.

With the invention thus explained, it is apparent that various modifications and variations can be made without departing from the spirit of the present invention. It is therefore intended that the invention be limited only as recited in the appended claims.

What is claimed is:

1. A gas supply apparatus adapted for supplying gas to a respiratory mask or patient interface, comprising:
a housing including a gas inlet, a gas outlet, and a gas flow path extending between and in fluid connection with said gas inlet and said gas outlet;
a blower disposed within said gas flow path for drawing gas into said gas flow path;
a gas filter disposed within said gas flow path for filtering the gas;
a breath tubing in fluid connection with said gas outlet of said housing for connecting to the respiratory mask or patient interface;
a particle sensor disposed within said housing, and operable to sense a particle concentration in gas and to generate a concentration signal representative of the particle concentration;
a signal processor electrically coupled to said particle sensor, and operable to evaluate when said gas filter should be replaced or cleaned according to said concentration signal and to generate an output signal; and
an indicator device electrically connecting to said signal processor and generating an alarm signal in response to said output signal.

2. The gas supply apparatus of claim 1, wherein said particle sensor is secured to said housing.

3. The gas supply apparatus of claim 2, further comprising a timer electrically coupled to said blower for detecting a working time of said blower, and generating a time signal representative of the working time, and a pressure sensor sensing a pressure in said gas flow path and generating a pressure signal representative of the pressure, said signal processor being electrically coupled to said timer and said pressure sensor, and being operable to receive and process said concentration signal, said time signal and said pressure signal, and to generate the output signal according to a result of processing said concentration signal, said time signal and said pressure signal.

4. The gas supply apparatus of claim 1, wherein said particle sensor is disposed within said gas flow path for sensing a particle concentration in the gas within said gas flow path.
